(19) United States
(12) Patent Application Publication
(10) Pub. No.: US 2017/0174326 A1
(43) Pub. Date: Jun. 22, 2017

(54) VORTEX GENERATORS AND METHOD OF CREATING VORTICES ON AN AIRCRAFT

(71) Applicant: Sikorsky Aircraft Corporation, Stratford, CT (US)

(72) Inventors: Patrick Bowles, Glastonbury, CT (US); Barbara Brenda Botros, Vernon, CT (US); ByungYoung Min, Glastonbury, CT (US); Claude G. Matalanis, Longmeadow, MA (US); Brian E. Wake, South Glastonbury, CT (US)

(21) Appl. No.: 15/265,502

(22) Filed: Sep. 14, 2016

Related U.S. Application Data
(60) Provisional application No. 62/269,351, filed on Dec. 18, 2015.

(51) Int. Cl. B64C 23/06; B64C 27/10

(52) U.S. Cl. CPC B64C 23/06; B64C 27/10; B64C 2027/8236

(57) ABSTRACT

A rotary wing aircraft includes a fuselage having a plurality of surfaces, at least one engine mounted in the fuselage, and a rotor assembly including a rotor shaft, and plurality of rotor blades operatively connected to the rotor shaft. The rotor assembly includes a plurality of surface portions. A plurality of vortex generators is mounted relative to at least one of the plurality of surfaces of the fuselage and the plurality of surface portions of the rotor assembly. The plurality of vortex generators operate to disrupt a boundary layer of air flowing over the one of the plurality of surfaces and the plurality of surface portions to reduce drag on the one of the fuselage and the rotor assembly.

### CROSS-REFERENCE TO RELATED APPLICATIONS

The present application claims priority to U.S. Provisional Application No. 62/269,351 filed on Dec. 18, 2015, the contents of which are incorporated by reference herein in their entirety.

### STATEMENT OF FEDERAL SUPPORT

This invention was made with Government support under Contract No.: W911W6-13-P-0010 awarded by the United States Army. The Government has certain rights in the invention.

### BACKGROUND

Exemplary embodiments pertain to the art of aircraft and, more particularly, to a vortex generator system and method for generating vortexes on a rotary wing aircraft.

Conventional rotary-wing aircraft have a forward airspeed limited by a number of factors. Among these is the existence of drag when traveling at high speeds. Various surfaces, both stationary and rotating, create drag as the aircraft moves through an airstream. Drag has a direct effect on aircraft power requirements, range, and efficiency. Accordingly, it is desirable to increase an overall airlift-to-equivalent-drag ratio (L/DE) to enhance an operational envelope of the rotary wing aircraft.

### BRIEF DESCRIPTION

Disclosed is a rotary wing aircraft including a fuselage having a plurality of surfaces, at least one engine mounted in the fuselage, and a rotor assembly including a rotor shaft, and plurality of rotor blades operatively connected to the rotor shaft. The rotor assembly includes a plurality of surface portions. A plurality of vortex generators is mounted relative to at least one of the plurality of surfaces of the fuselage and the plurality of surface portions of the rotor assembly. The plurality of vortex generators operate to disrupt a boundary layer of air flowing over the one of the plurality of surfaces and the plurality of surface portions to reduce drag on the one of the fuselage and the rotor assembly.

In addition to one or more of the features described above or below, or as an alternative, further embodiments could include wherein the rotor assembly includes a shaft fairing extending about the rotor shaft and a hub member arranged adjacent to the plurality of rotor blades, the plurality of vortex generators being fixedly mounted to one of the shaft fairing and the hub member.

In addition to one or more of the features described above or below, or as an alternative, further embodiments could include wherein the plurality of vortex generators comprise a plurality of guide vanes extending along the one of the shaft fairing and the hub member.

In addition to one or more of the features described above or below, or as an alternative, further embodiments could include wherein the plurality of guide vanes include a first plurality of guide vanes extending along the one of the shaft fairing and the hub member at a first angle, and a second plurality of guide vanes extending along the one of the shaft fairing and the hub member at a second angle distinct from the first angle.

In addition to one or more of the features described above or below, or as an alternative, further embodiments could include wherein the plurality of vortex generators comprise a plurality of generally circular bumps formed on the one of the shaft fairing and the hub member.

In addition to one or more of the features described above or below, or as an alternative, further embodiments could include wherein the shaft fairing includes a first lateral side surface portion and a second, opposing lateral side surface portion, and the hub member includes an upper surface portion, the plurality of vortex generators extending outwardly from one or more of the first and second lateral side surface portions of the shaft fairing and the upper surface portion of the hub member.

In addition to one or more of the features described above or below, or as an alternative, further embodiments could include wherein the plurality of vortex generators comprise selectively deployable vortex generators that are shiftable between a stowed position in which the plurality of selectively deployable vortex generators are not exposed to an airstream and a deployed position, wherein the plurality of selectively deployable vortex generators are exposed to the airstream.

In addition to one or more of the features described above or below, or as an alternative, further embodiments could include wherein the rotor assembly includes a shaft fairing extending about the rotor shaft and a hub member arranged adjacent to the plurality of rotor blades, the plurality of selectively deployable vortex generators being deployable mounted in one of the shaft fairing and the hub member.

In addition to one or more of the features described above or below, or as an alternative, further embodiments could include wherein the shaft fairing includes a first lateral side surface portion and a second, opposing lateral side surface portion, and the hub member includes an upper surface portion, the plurality of selectively deployable vortex generators selectively extending outwardly from one or more of the first and second lateral side surface portions of the shaft fairing and the upper surface portion of the hub member.

In addition to one or more of the features described above or below, or as an alternative, further embodiments could include a controller operatively connected to the plurality of selectively deployable vortex generators, the controller operating to extend one or more of the selectively deployable vortex generators through one or more of the first and second lateral side surface portions of the shaft fairing and the upper surface portion of the hub member.

Also disclosed is a method of creating vortices on a rotary wing aircraft to decrease drag including guiding an airstream across at least one of a plurality of surfaces of a fuselage and a plurality of surface portions of a rotor assembly, interrupting the airstream with a plurality of vortex generators extending outwardly of the one of the plurality of surfaces of the fuselage and the plurality of surface portions of the rotor assembly, and reducing drag on the one of the plurality of surfaces of the fuselage and the plurality of surface portions of the rotor assembly by creating vortices in the airstream with the plurality of vortex generators.

In addition to one or more of the features described above or below, or as an alternative, further embodiments could include wherein interrupting the airflow with the plurality of vortex generators includes positioning a plurality of guide vanes on one of a shaft fairing and a hub member of the rotor assembly.

In addition to one or more of the features described above or below, or as an alternative, further embodiments could include wherein positioning the plurality of guide vanes includes positioning a first plurality of guide vanes extending along the one of the shaft fairing and the hub member at a first angle, and a second plurality of guide vanes extending along the one of the shaft fairing and the hub member at a second angle distinct from the first angle.

In addition to one or more of the features described above or below, or as an alternative, further embodiments could include wherein interrupting the airflow with the plurality of vortex generators includes positioning a plurality of generally circular bumps on one of a shaft fairing and a hub member of the rotor assembly.

In addition to one or more of the features described above or below, or as an alternative, further embodiments could include wherein interrupting the airflow with the plurality of vortex generators includes selectively shifting the plurality of vortex generators between a stowed position in which the plurality of vortex generators are exposed to the airstream and a deployed position, wherein the plurality of vortex generators are exposed to the airstream.

### BRIEF DESCRIPTION OF THE DRAWINGS

The following descriptions should not be considered limiting in any way. With reference to the accompanying drawings, like elements are numbered alike:

FIG. 1 depicts a rotary wing aircraft, in accordance with an exemplary embodiment;

FIG. 2 is a perspective view of a rotary wing aircraft, in accordance with an exemplary embodiment;

FIG. 3 depicts a side view of a shaft fairing including a vortex generator, in accordance with an aspect of an exemplary embodiment;

FIG. 4 depicts a vortex generator, in accordance with an aspect of an exemplary embodiment;

FIG. 5 depicts a vortex generator, in accordance with another aspect of an exemplary embodiment;

FIG. 6 depicts a vortex generator, in accordance with yet another aspect of an exemplary embodiment;

FIG. 7 depicts a vortex generator, in accordance with still yet another aspect of an exemplary embodiment;

FIG. 8 depicts a rotor hub including vortex generators in accordance with an aspect of an exemplary embodiment;

FIG. 9 depicts selectively deployable vortex generators deployed from a shaft fairing in accordance with an aspect of an exemplary embodiment; and

FIG. 10 depicts the selectively deployable vortex generators of FIG, 9 in a non-deployed configuration.

### DETAILED DESCRIPTION

A detailed description of one or more embodiments of the disclosed apparatus and method are presented herein by way of exemplification and not limitation with reference to the Figures.

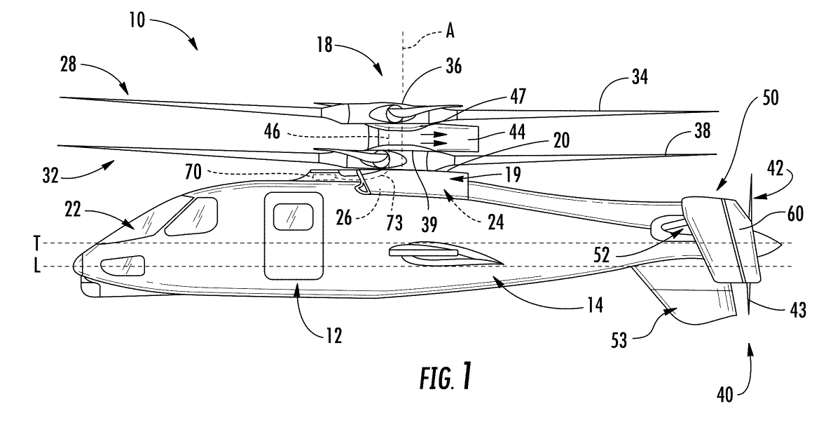

FIGS. 1 and 2 depict an exemplary embodiment of a rotary wing, vertical takeoff and land (VTOL) aircraft 10. The aircraft 10 includes an airframe or fuselage 12 with an extending tail 14. A dual, counter rotating, coaxial main rotor assembly 18 extends outwardly from a pylon 19 having an upper surface 20 of fuselage 12 and rotates about a main rotor axis, A. In an exemplary embodiment, the fuselage 12 includes a cockpit 22 having two seats for flight crew (e.g., pilot and co-pilot) and six seats for passengers (not shown). Main rotor assembly 18 is driven by a power source, for example, one or more engines 24 via a gearbox 26. Main rotor assembly 18 includes an upper rotor assembly 28 that may be driven in a first direction (e.g., counter-clockwise) about the main rotor axis, A, and a lower rotor assembly 32 that may be driven in a second direction (e.g., clockwise) about the main rotor axis, A, opposite to the first direction (i.e., counter rotating rotors).

In the exemplary embodiment shown, upper rotor assembly 28 includes a first plurality of rotor blades 34 supported by a first or upper rotor hub 36. Lower rotor assembly 32 includes a second plurality of rotor blades 38 supported by a second, or lower rotor hub 39. In some embodiments, the aircraft 10 may include a translational thrust system 40 having a propeller 42 located at the extending tail 14 to provide translational thrust (forward or rearward) for aircraft 10. Propeller 42 includes a plurality of blades 43.

Main rotor assembly 18 also includes a shaft fairing 44 generally located between and around the upper and lower rotor assemblies 28 and 32 such that lower rotor hub 39 may be at least partially contained therein. Shaft fairing 44 extends about a rotor shaft 46 operatively connecting upper rotor assembly 28 and engine(s) 24. Shaft fairing 44 extends between lower rotor hub 39 and an upper rotor hub member 47 arranged inwardly of upper rotor assembly 28 and operates to reduce drag which might otherwise exist at rotor shaft 46. First plurality of rotor blades 34 is connected to upper rotor hub 36 in a hingeless manner, also referred to as a rigid rotor system. Similarly, second plurality of rotor blades 38 is connected to lower rotor hub 39 in a hingeless manner.

Although a particular aircraft configuration is illustrated in this non-limiting embodiment, other rotary wing aircraft will also benefit from embodiments of the invention. Although, the dual rotor system is depicted as coaxial, embodiments include dual rotor aircraft having non-coaxial rotors. Further, it should be understood that exemplary embodiments could also be incorporated into a rotary wing aircraft having a single rotor assembly.

Propeller 42, or translational thrust system 40, is connected to, and driven by, the engine 24 via the gearbox 26. Translational thrust system 40 may be mounted to the rear of the fuselage 12 with a translational thrust axis, T, oriented substantially horizontal and parallel to the aircraft longitudinal axis, L, to provide thrust for high-speed flight. The term “parallel” should be understood to include a translational thrust axis that is coincident with the longitudinal axis. Translational thrust axis, T, corresponds to the axis of rotation of propeller 42. While shown in the context of a pusher-prop configuration, it is understood that the propeller 42 could also be a more conventional puller prop or could be variably facing so as to provide yaw control in addition to, or instead of, translational thrust. It should be understood that any such system or other translational thrust systems may alternatively or additionally be utilized. Alternative translational thrust systems may include different propulsion forms, such as a jet engine.

In accordance with an aspect of an exemplary embodiment, propeller blades 43 of translational thrust system 40 may include a variable pitch. More specifically, the pitch of propeller blades 43 may be altered to change the direction of thrust (e.g., forward or rearward). In accordance with another aspect of an exemplary embodiment, extended tail 14 includes a tail section 50 including starboard and port horizontal stabilizers 51 and 52. Tail section 50 also includes a vertical stabilizer 53 that extends downward from extending tail 14. Starboard horizontal stabilizer 51 includes a starboard active elevator 54 and a starboard active rudder 56. Similarly, port horizontal stabilizer 52 includes a port active elevator 58 and a port active rudder 60. Elevators 54 and 58 and rudders 56 and 60 act as controllable surfaces, e.g., surfaces that alter a flight path/characteristics of aircraft 10.

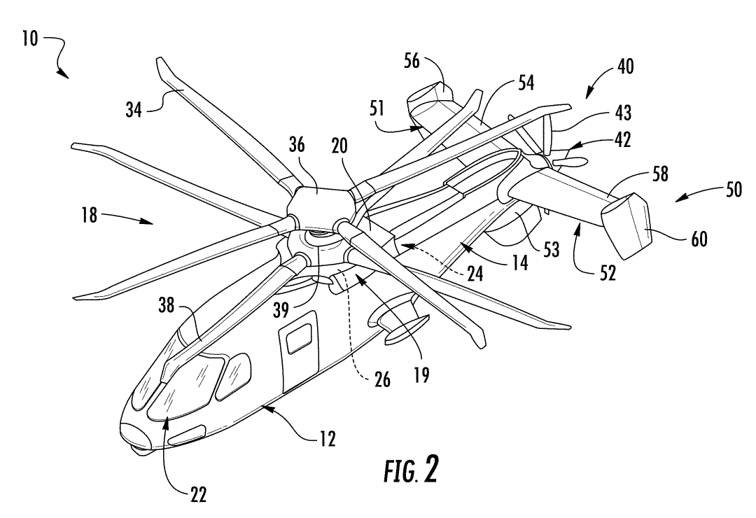

In accordance with an aspect of an exemplary embodiment illustrated in FIG. 3, wherein rotor assembly 18 has been removed for sake of clarity and understanding, shaft fairing 44 includes a forward or leading edge surface portion 90, and an aft or trailing edge surface portion 92. A first lateral side surface portion 95 extends between leading edge surface portion 90 and trailing edge surface portion 92. Similarly, a second, opposing lateral side surface portion (FIG. 7) extends between leading edge portion 90 and trailing edge portion 92. Also shown in FIG. 3, upper hub member 47 includes an upper surface portion 100.

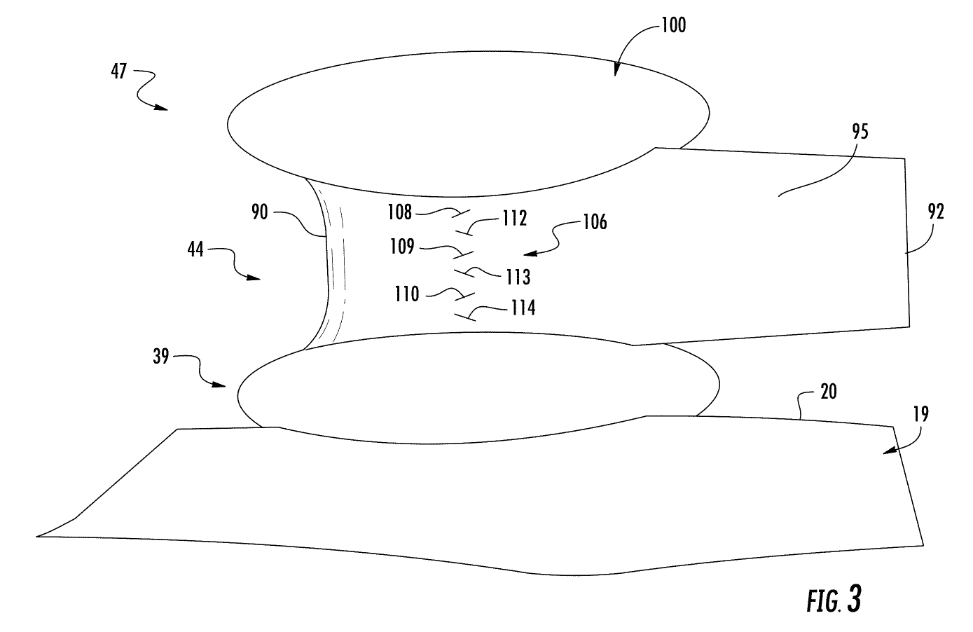

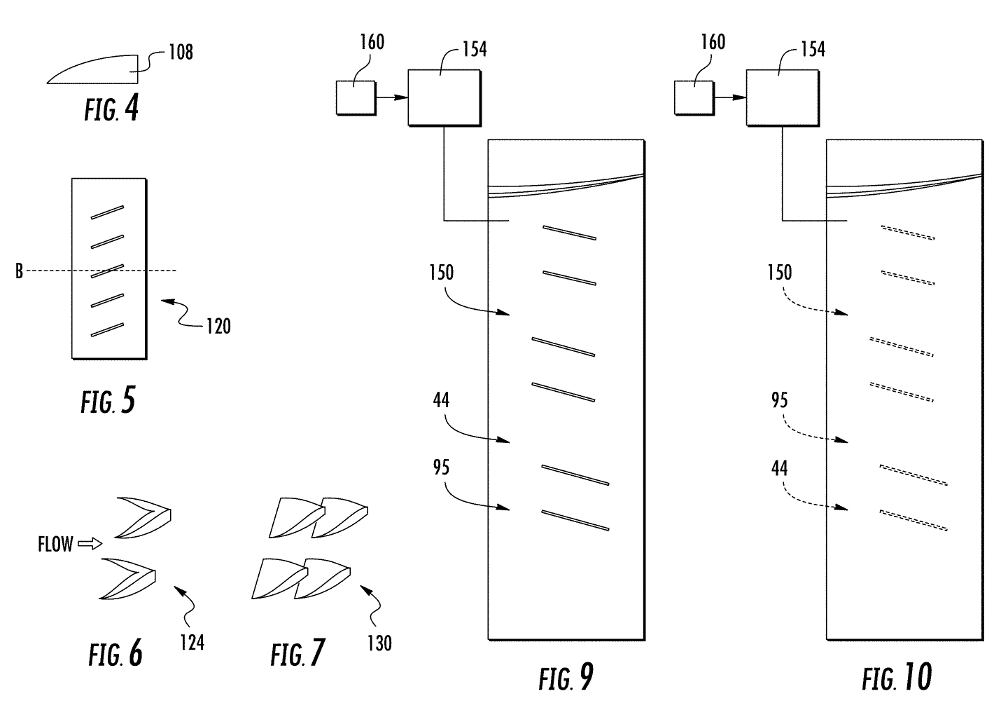

In accordance with an aspect of an exemplary embodiment, aircraft 10 includes a plurality of vortex generators 106 fixedly mounted to first lateral side surface portion 95 of shaft fairing 44. It should be understood that additional vortex generators (not shown) may be provided on second lateral side surface portion 96. In the exemplary aspect shown, plurality of vortex generators 106 includes a first plurality of vortex generators 108-110 extending outwardly of first lateral side surface portion 95. A second plurality of vortex generators 112-114 also extend outwardly of first lateral side surface 95. First and second pluralities of vortex generators 108-110 and 112-114 may have a generally triangular profile such as shown in connection with vortex generator 108 in FIG. 4.

First plurality of vortex generators 108-110 are arranged at a first angle relative to a longitudinal axis “B” of shaft fairing 44. Second plurality of vortex generators 112-114 extend at a second angle relative to longitudinal axis “B” that is distinct from the first angle. In accordance with an aspect of an exemplary embodiment, first and second angles may be complimentary angles. Further, it should be understood that first and second pluralities of vortex generators 108-110 and 112-114 may extend outwardly of first lateral side surface portion 95 at a non-perpendicular angle which may vary for each vortex generator 108-110, and 112-114.

In accordance with another aspect of an exemplary embodiment, a plurality of vortex generators 120 illustrated in FIG. 5 may extend at a similar angle relative to longitudinal axis “B”. The particular angle chosen, and whether the angles are different or similar, may depend on a desired rotational direction of produced vortices. For example, vortex generators 120 shown in FIG. 5 may produce co-rotating vortices that pass over shaft fairing 44. Further, the particular geometry and arrangement of vortex generators may vary. For example, FIG. 6 depicts vortex generators 124 having a generally wishbone shape and FIG. 7 depicts vortex generators 130 arranged in doublets.

In accordance with another aspect of an exemplary embodiment illustrated in FIG. 8, a plurality of vortex generators 138 may be arranged on upper surface 100 of upper hub member 47. Vortex generators 138 may take the form of circular bumps such as indicated at 140. Vortex generators 138 are arranged annularly about upper surface 100. It should however be understood that the particular arrangement and location of vortex generators 138 may vary. Also, it should be understood that the particular shape of vortex generators 138 may vary.

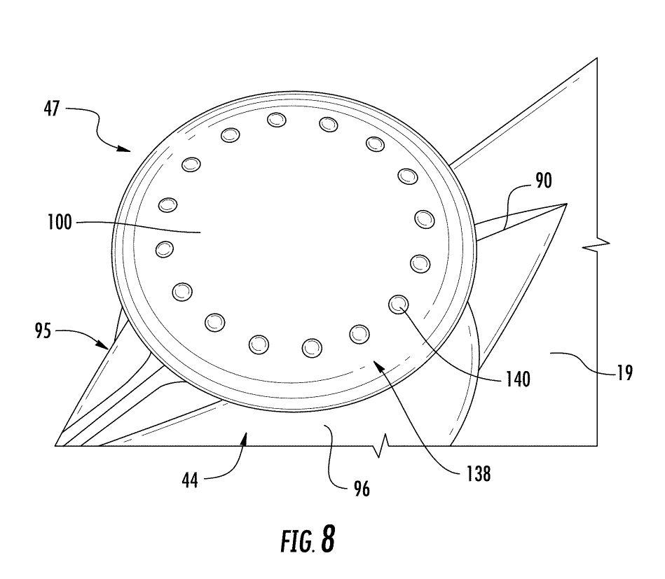

FIG. 9 depicts a plurality of selectively deployable vortex generators 150 arranged on first lateral side surface portion 95 of shaft fairing 44. Selectively deployable vortex generators 150 are selectively shiftable between a first, or deployed position such as shown in FIG. 9 and a second, or stowed position, such as shown in FIG. 10. Selectively deployable vortex generators 150 may be coupled to a controller 154. Controller 154 may actively or passively facilitate shifting between the deployed and stowed configuration. Controller 154 may be coupled to one or more sensors 160 that detect air currents on shaft fairing 44. Based on inputs from sensors 160, controller 154 may deploy or retract selectively deployable vortex generators 150. When deployed, selectively deployable vortex generators 150 produce counter-rotating vortices on shaft fairing 44.

Vortex generators 106, in accordance with an aspect of an exemplary embodiment, are arranged at an angle to incident flow over a corresponding surface. In accordance with one example, vortex generators are arranged at an angle between about 4° and about 30° relative to incident flow. In accordance with another example, vortex generators may be arranged at an angle of about 20° relative to incident. In accordance with another aspect of an exemplary embodiment, vortex generators may include a chord length to height ratio of between about 2 to 6. In accordance with another aspect of an exemplary embodiment, the chord length to height ratio may be about 4. In accordance with yet another aspect of an exemplary embodiment, a ratio spacing between pairs of vortex generators relative to vortex generator height may be between about 0.1 to 6. In accordance with still yet another aspect, vortex generators 106 may have a height that is substantially equal to a height of a boundary layer of air flowing over the corresponding surface. Further, each vortex generator may include a thickness that is as thin as structurally feasible. In accordance with yet another aspect, vortex generators may be placed at a position on the corresponding surface that enhances drag reduction while also achieving a desired separation reduction. It should also be understood that while described in terms of reducing drag on a shaft fairing and a hub, exemplary embodiments could be employed on other surfaces of the aircraft. Further, it should be understood that the exemplary embodiments are not limited to deployment on rotary wing aircraft and could be utilized on other aircraft designed such as fixed wing aircraft, as well as manned and un-manned aircraft. Additionally, while shown on the shaft fairing, deployable vortex generators may be provided on other surfaces such as on the upper surface of the fuselage, and the upper and/or side surfaces of the upper hub member and side surfaces of pylon 19.

The terminology used herein is for the purpose of describing particular embodiments only and is not intended to be limiting of the present disclosure. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, element components, and/or groups thereof.

While the present disclosure has been described with reference to an exemplary embodiment or embodiments, it will be understood by those skilled in the art that various changes may be made and equivalents may be substituted for elements thereof without departing from the scope of the present disclosure. In addition, many modifications may be made to adapt a particular situation or material to the teachings of the present disclosure without departing from the essential scope thereof. Therefore, it is intended that the present disclosure not be limited to the particular embodiment disclosed as the best mode contemplated for carrying out this present disclosure, but that the present disclosure will include all embodiments falling within the scope of the claims.

What is claimed is:

1. A rotary wing aircraft comprising:
a fuselage including a plurality of surfaces;
at least one engine mounted in the fuselage;
a rotor assembly including a rotor shaft and plurality of rotor blades operatively connected to the rotor shaft, the rotor assembly including a plurality of surface portions; and
a plurality of vortex generators mounted relative to at least one of the plurality of surfaces of the fuselage and the plurality of surface portions of the rotor assembly, the plurality of vortex generators operating to disrupt a boundary layer of air flowing over the at least one of the plurality of surfaces and the plurality of surface portions to reduce drag on the one of the fuselage and the rotor assembly.

2. The rotary wing aircraft according to claim 1, wherein the rotor assembly includes a shaft fairing extending about the rotor shaft and a hub member arranged adjacent to the plurality of rotor blades, the plurality of vortex generators being fixedly mounted to one of the shaft fairing and the hub member.

3. The rotary wing aircraft according to claim 2, wherein the plurality of vortex generators comprise a plurality of guide vanes extending along the one of the shaft fairing and the hub member.

4. The rotary wing aircraft according to claim 3, wherein the plurality of guide vanes include a first plurality of guide vanes extending along the one of the shaft fairing and the hub member at a first angle, and a second plurality of guide vanes extending along the one of the shaft fairing and the hub member at a second angle distinct from the first angle.

5. The rotary wing aircraft according to claim 2, wherein the plurality of vortex generators comprise a plurality of generally circular bumps formed on the one of the shaft fairing and the hub member.

6. The rotary wing aircraft according to claim 2, wherein the shaft fairing includes a first lateral side surface portion and a second, opposing lateral side surface portion, and the hub member includes an upper surface portion, the plurality of vortex generators extending outwardly from one or more of the first and second lateral side surface portions of the shaft fairing and the upper surface portion of the hub member.

7. The rotary wing aircraft according to claim 1, wherein the plurality of vortex generators comprise a plurality of selectively deployable vortex generators that are shiftable between a stowed position in which the plurality of selectively deployable vortex generators are not exposed to an airstream and a deployed position, wherein the plurality of selectively deployable vortex generators are exposed to the airstream.

8. The rotary wing aircraft according to claim 7, wherein the rotor assembly includes a shaft fairing extending about the rotor shaft and a hub member arranged adjacent to the plurality of rotor blades, the plurality of selectively deployable vortex generators being deployably mounted in one of the shaft fairing and the hub member.

9. The rotary wing aircraft according to claim 8, wherein the shaft fairing includes a first lateral side surface portion and a second, opposing lateral side surface portion, and the hub member includes an upper surface portion, the plurality of selectively deployable vortex generators selectively extending outwardly from one or more of the first and second lateral side surface portions of the shaft fairing and the upper surface portion of the hub member.

10. The rotary wing aircraft according to claim 9, further comprising: a controller operatively connected to the plurality of selectively deployable vortex generators, the controller operating to extend one or more of the selectively deployable vortex generators through one or more of the first and second lateral side surface portions of the shaft fairing and the upper surface portion of the hub member.

11. A method of decreasing drag on a surface of a rotary wing aircraft comprising:
guiding an airstream across at least one of a plurality of surfaces of a fuselage and a plurality of surface portions of a rotor assembly;
interrupting the airstream with a plurality of vortex generators extending outwardly of the one of the plurality of surfaces of the fuselage and the plurality of surface portions of the rotor assembly; and
reducing drag on the one of the plurality of surfaces of the fuselage and the plurality of surface portions of the rotor assembly by creating vortices in the airstream with the plurality of vortex generators.

12. The method of claim 11, wherein interrupting the airflow with the plurality of vortex generators includes positioning a plurality of guide vanes on one of a shaft fairing and a hub member of the rotor assembly.

13. The method of claim 12, wherein positioning the plurality of guide vanes includes positioning a first plurality of guide vanes extending along the one of the shaft fairing and the hub member at a first angle, and a second plurality of guide vanes extending along the one of the shaft fairing and the hub member at a second angle distinct from the first angle.

14. The method of claim 11, wherein interrupting the airflow with the plurality of vortex generators includes positioning a plurality of generally circular bumps on one of a shaft fairing and a hub member of the rotor assembly.

15. The method of claim 11, wherein interrupting the airflow with the plurality of vortex generators includes selectively shifting the plurality of vortex generators between a stowed position in which the plurality of vortex generators are exposed to the airstream and a deployed position, wherein the plurality of vortex generators are exposed to the airstream.
